(19) United States
(12) Patent Application Publication
(10) Pub. No.: US 2015/0180769 A1
(43) Pub. Date: Jun. 25, 2015

(54) SCALE-UP OF SDN CONTROL PLANE USING VIRTUAL SWITCH BASED OVERLAY

(71) Applicants: An Wang, Fairfax, VA (US); Yang Guo, Princeton Junction, NJ (US); Fang Hao, Morganville, NJ (US); Tirunell V. Lakshman, Morganville, NJ (US)

(72) Inventors: An Wang, Fairfax, VA (US); Yang Guo, Princeton Junction, NJ (US); Fang Hao, Morganville, NJ (US); Tirunell V. Lakshman, Morganville, NJ (US)

(73) Assignee: Alcatel-Lucent USA Inc., Murray Hill, NJ (US)

(21) Appl. No.: 14/137,047

(22) Filed: Dec. 20, 2013

(51) Int. Cl. H04L 12/713; H04L 12/803; H04L 12/851; H04L 12/721; H04L 12/813

(52) U.S. Cl. CPC H04L 45/586; H04L 45/38; H04L 47/20; H04L 47/2483; H04L 47/125

(57) ABSTRACT

A capability for scale-up of a control plane of a Software Defined Network (SDN) using a virtual switch based overlay is presented. A central controller (CC) of the SDN that is providing control functions for a physical switch (pSwitch) of the SDN, based on a determination that the control plane between the CC and the pSwitch is congested, modifies the default flow forwarding rule on the pSwitch from a rule indicating that new traffic flows are to be forwarded to the central controller to a rule indicating that new traffic flows are to be forwarded to a virtual switch (vSwitch). Upon receipt of a first packet of a new traffic flow at the pSwitch, the pSwitch provides the first packet of the new traffic flow to the vSwitch, which in turn provides an indication of the first packet of the new traffic flow to the CC for processing by the CC.

### TECHNICAL FIELD

The disclosure relates generally to communication networks and, more specifically but not exclusively, to Software Defined Networking (SDN).

### BACKGROUND

Software Defined Networking has emerged as a networking paradigm of much research and commercial interest.

### SUMMARY OF EMBODIMENTS

Various deficiencies in the prior art are addressed by embodiments for scaling a control plane of a software defined network.

In at least some embodiments, an apparatus includes a processor and a memory communicatively connected to the processor, where the processor is configured to propagate, toward a physical switch of the software defined network, a default flow forwarding rule indicative that, for new traffic flows received at the physical switch, associated indications of the new traffic flows are to be directed to a virtual switch. In at least some embodiments, an associated method is provided. In at least some embodiments, a computer-readable storage medium stored instructions which, when executed by a computer, cause the computer to perform an associated method.

In at least some embodiments, an apparatus includes a processor and a memory communicatively connected to the processor, where the processor is configured to receive, from a virtual switch, a new flow request message associated with a first packet of a new traffic flow received by a physical switch of the software defined network, and process the new flow request message received from the virtual switch. In at least some embodiments, a computer-readable storage medium stores instructions which, when executed by a computer, cause the computer to perform a method including functions described as being performed by the apparatus. In at least some embodiments, a method includes using a processor and a memory to perform functions described as being performed by the apparatus.

In at least some embodiments, an apparatus includes a processor and a memory where the memory is configured to store a flow table including a default flow forwarding rule and the processor, which is communicatively connected to the memory, is configured to receive a first packet of a new traffic flow and propagate the first packet of the new traffic flow toward a virtual switch based on the default flow forwarding rule. In at least some embodiments, a computer-readable storage medium stores instructions which, when executed by a computer, cause the computer to perform a method including functions described as being performed by the apparatus. In at least some embodiments, a method includes using a processor and a memory to perform functions described as being performed by the apparatus.

In at least some embodiments, an apparatus includes a processor and a memory communicatively connected to the processor, where the processor is configured to receive, from a physical switch of the software defined network, a first packet of a new traffic flow, and propagate, toward a central controller of the software defined network, a new flow request message determined based on the first packet of the new traffic flow received from the physical switch. In at least some embodiments, a computer-readable storage medium stores instructions which, when executed by a computer, cause the computer to perform a method including functions described as being performed by the apparatus. In at least some embodiments, a method includes using a processor and a memory to perform functions described as being performed by the apparatus.

### BRIEF DESCRIPTION OF THE DRAWINGS

The teachings herein can be readily understood by considering the following detailed description in conjunction with the accompanying drawings, in which:

FIG. 1 depicts an exemplary communication system using a vSwitch-based overlay network to provide scaling of SDN control plane capacity of an SDN;

FIG. 2 depicts the communication system of FIG. 1, illustrating use of the vSwitch-based overlay network to support establishment of a data path through the SDN for a new traffic flow;

FIG. 3 depicts an exemplary central controller configured to support fair sharing of resources of an SDN based on ingress port differentiation and migration of large traffic flow within an SDN;

FIG. 4 depicts an exemplary portion of an SDN configured to support migration of a traffic flow from the vSwitch-based overlay network to the physical network portion of the SDN in a manner for ensuring that the same policy constraints are satisfied;

FIG. 5 depicts one embodiment of a method for use by a central controller of an SDN using a vSwitch-based overlay network;

FIG. 6 depicts one embodiment of a method for use by a central controller of an SDN using a vSwitch-based overlay network;

FIG. 7 depicts one embodiment of a method for use by a pSwitch of an SDN using a vSwitch-based overlay network;

FIG. 8 depicts one embodiment of a method for use by a vSwitch of an SDN using a vSwitch-based overlay network; and

FIG. 9 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

Software Defined Networking has emerged as a networking paradigm of much research and commercial interest. In general, a key aspect of a Software Defined Network (SDN) is separation of the control plane (typically referred to as the SDN control plane) and the data plane (typically referred to as the SDN data plane). The data plane of the SDN is distributed and includes a set of forwarding elements (typically referred to as switches) that are controlled via the control plane. The control plane of the SDN is logically centralized and includes a central controller (or multiple central controllers) configured to control the switches of the data plane using control channels between the central controller and the switches of the data plane. Thus, the switches also may be considered to include control plane portions which are configured to handle control messages from the central controller. More specifically, the switches perform handling of traffic flows in the SDN under the control of the central controller, where the switches include respective flow tables which may be used by the switches for handling packets of traffic flows received at the respective switches and the central controller configures the respective flow tables used by the switches for handling packets of traffic flows received at the respective switches. The central controller may configure the flow tables of the switches in proactive mode (e.g., a priori configured) or reactive mode (e.g., on demand). The reactive mode, which typically permits finer-grained control of flows, is generally invoked when a new flow is detected at a switch and the flow table at the switch does not include an entry corresponding to the new flow, and typically requires control-based communications between the switch and the central controller in order to enable the SDN to support the new flow. It will be appreciated that the SDN may be implemented using any suitable type of SDN architecture (e.g., OpenFlow, a proprietary SDN architecture, of the like).

While use of logically centralized control provides various benefits for SDNs (e.g., maintaining a global network view, simplifying programmability, and the like), use of logically centralized control in the form of a central controller can negatively affect SDN performance if the control plane between the central controller and switches controlled by the central controller becomes a bottleneck. Namely, since the central controller and switches controlled by the central controller are separated and handling of reactive flows depends upon communication between the central controller and switches controlled by the central controller, it is important that there are no conditions that interrupt or limit communications between the central controller and switches controlled by the central controller. This may be particularly important if a switch is configured to operate with a relatively large fraction of reactive flows requiring communication between the switch and its central controller. For example, communication bottlenecks impacting communications between the central controller and a switch may lead to poor performance of the switch (especially for reactive flows), and complete saturation of the communication channel between the central controller and a switch may essentially render the switch disconnected from the central controller such that the flow table of the switch cannot be changed in response to new flow or network conditions. It will be appreciated that such conditions which may impact communications between the central controller and switches controlled by the central controller may result from conditions in the SDN, attacks on the SDN, or the like, as well as various combinations thereof. For example, network conditions such as flash crowds, failure conditions, or the like, may reduce or stop communications between the central controller and switches controlled by the central controller. Similarly, for example, a malicious user may attempt to saturate communication channels between the central controller and switches controlled by the central controller in order to negatively impact or even stop network operation by reducing or stopping communications between the central controller and switches controlled by the central controller. It will be appreciated that various other conditions may impact communication between the central controller and a switch or switches.

In a typical SDN based on OpenFlow, control functions are provided by an OpenFlow central controller and packet processing forwarding functions are provided by a set of OpenFlow switches. In general, each of the OpenFlow switches includes a data plane portion and a control plane portion (typically referred to as the Open Flow Agent (OFA)). The data plane of a switch is responsible for packet processing and forwarding, while the OFA of the switch allows the central controller to interact with the data plane of the switch such that the central controller can control the behavior of the data plane of the switch. The OFA of the switch may communicate with the central controller via a communication channel (e.g., via a secure connection such as a secure Transmission Control Protocol (TCP) connection or any other suitable type of connection). As described above, each switch maintains a flow table (or multiple flow tables) storing flow forwarding rules according to which traffic flows are processed at and forwarded by the switch. In a typical SDN based on OpenFlow, when a packet of a traffic flow arrives at a switch, the data plane of the switch performs a lookup in the flow table of the switch, based on information in the packet, in order to determine handling of the packet at the switch. If the packet does not match any existing rule in the flow table, the data plane of the switch treats the packet as a first packet of a new flow and passes the packet to the OFA of the switch. The OFA of the switch encapsulates the packet into a Packet-In message and propagates the message to the central controller via the secure connection between the switch and the central controller. The Packet-In message includes either the packet header or the entire packet, depending on the configuration, as well as other information (e.g., the ingress port of the switch on which the packet was received or the like). The central controller, upon receiving the Packet-In message from the switch, determines handling of the traffic flow of the packet (e.g., based on one or more of policy settings, global network state, or the like). The central controller may determine whether or not the traffic flow is to be admitted to the SDN. If the flow is admitted, the central controller computes the flow path and installs forwarding rules for the traffic flow at switches along the flow path computed by the central controller for the traffic flow. The central controller may install the flow forwarding rules at the switches by sending flow modification commands to each of the switches. The OFAs of the switches, upon receiving the respective flow modification commands from the central controller, install the flow forwarding rules into the respective flow tables of the switches. The central controller also may send a Packet-Out message to the switch from which the Packet-In message was received (i.e., the switch that received the first packet of the new traffic flow) in order to explicitly instruct the switch regarding forwarding of the first packet of the new traffic flow.

While there are various benefits of using the typical SDN based on OpenFlow that is described above (as well as other variations of SDNs based on OpenFlow), one problem with the current OpenFlow switch implementation is that the OFA of the switch typically runs on a relatively low-end CPU that has relatively limited processing power (e.g., as compared with the CPU used to support the central controller). While this seems to be an understandable design choice (given that one intention of the OpenFlow architecture is to move the control functions out of the switches so that the switches can be implemented as simpler, lower cost forwarding elements), this implementation can significantly limit the control plane throughput. This limitation may be problematic in various situations discussed above (e.g., during conditions which impact communications between the central controller and switches controlled by the central controller, which may include naturally occurring conditions, attacks, or the like). Additionally, although the communication capacity between data plane and central controller may improve over time in the future, it is expected that the data plane capacity of a switch will always be much greater than the control plane capacity of the switch such that, even if the control plane capacity of switches in the future is relatively high compared with control plane capacity of switches today, the control plane capacity of the switch may still get overwhelmed under certain conditions (e.g., during a DoS attack, when there are too many reactive flows, or the like).

This limitation of the typical SDN based on OpenFlow may be better understood by considering a Distributed Denial-of-Service (DDoS) attack scenario in which a DDoS attacker generates spoofed packets using spoofed source IP addresses. The switch treats each spoofed packet as a new traffic flow and forwards each spoofed packet to the central controller. However, the insufficient processing power of the OFA of the switch limits the rate at which the OFA of the switch can forward the spoofed packets to central controller, as well as the rate at which the OFA of the switch can insert new flow forwarding rules into the flow table of the switch as responses for the spoofed packets are received from the central controller. In other words, a DDoS attack can cause Packet-In messages to be generated at much higher rate than what the OFA of the switch is able to handle, effectively making the central controller unreachable from the switch and causing legitimate traffic flows to be blocked from the OpenFlow SDN even though there is no data plane congestion in the OpenFlow SDN. It will be appreciated that the DDoS attack scenario merely represents one type of situation which may cause control plane overload, and that blocking of legitimate traffic flows may occur when the control plane is overloaded due to other types of conditions.

The impact of control plane overload on SDN packet forwarding performance due to an attempted DDoS was evaluated in a testbed environment. The testbed environment included a server, a client, and an attacker, where the client and the attacker were both configured to initiate new flows to the server. The communication between the client and the attacker and the server is via an SDN including a set of switches. The testbed environment used two hardware switches as follows: a Pica8 Pronto 3780 switch and an HP Procurve 6600 switch, with OpenFlow 1.2 and 1.0 support, respectively. The testbed environment, for comparison purposes, also used a virtual switch running on a host with an Intel Xeon 5650 2.67 GHz CPU. The testbed environment also used a Ryu OpenFlow controller, which supports OpenFlow 1.2 and is the default controller used by Pica8. The Pica8 switch had 10 Gbps data ports, and the HP switch and the virtual switch each had 1 Gbps data ports. The management ports for all three of the switches were 1 Gbps ports. The client, attacker, and server were each attached to the data ports, and the central controller was attached to the management port. The hping3 network tool was used to generate attacking traffic. The switches were evaluated one at a time. When evaluating a switch, both the client and the attacker attempt to initiate new flows to the server (the new flow rate of the client was set to be constant at 100 flows/sec, and the new flow rate of the attacker was varies between 10 flows/sec and 3800 flows/sec), the flow rate at both the sender and receiver sides was monitored, and the associated flow failure rate (i.e., the fraction of flows, from amongst all the flows, that cannot go through the switch) was calculated. It was determined that both of the hardware switches had a much higher flow failure rate than the virtual switch. It also was determined that, even at the peak attack rate of 3800 flows/sec, the attack traffic was still only a small fraction of the data link bandwidth, indicating that the bottleneck is in the control plane rather than in the data plane. The testbed environment also was used to identify which component of the control plane is the actual bottleneck of the control plane. Recalling that a new flow received at a switch may only be successfully accepted at the switch if the required control plane actions (namely, sending a Packet-In message from the OFA of the switch to the central controller; (2) sending of a new flow forwarding rule from the central controller to the OFA of the switch; and (3) insertion, by the OFA of the switch, of the new flow forwarding rule into the flow table of the switch) are completed successfully, it was determined that identification of the component of the control plane that is the actual bottleneck of the control plane may be performed based on measurements of the Packet-In message rate, the flow forwarding rule insertion event rate, and the received packet rate at the destination (i.e., the rate at which new flows successfully pass through the switch and reach the destination). In the experiments it was determined, for at least one of the switches, that the Packet-In message rate, the flow rule insertion event rate, and the received packet rate at the destination were identical or nearly identical. It also was determined that even with a maximum packet size of 1.5 KB, the peak rate for 150 Packet-Ins/sec was 1.8 Mbps, which is well below the 1 Gbps control link bandwidth. These results were analyzed and determined to be suggestive that the capability of the OFA in generating Packet-In messages is the bottleneck, or at least a primary contributor to the bottleneck of the control plane in typical OpenFlow-based SDN implementations. It is noted that further experimentation produced results which, when analyzed, were determined to be suggestive that the rule insertion rate supported by the switch is greater than the Packet-In message rate supported by the switch.

Based on the discussion above, the following observations have been made regarding scaling of the SDN control plane: (1) the control plane at the physical switches has limited capacity (e.g., the maximum rate at which new flows can be set up at the switch is relatively low—typically several orders of magnitude lower than the data plane rate); (2) vSwitches, when compared with physical switches, have higher control plane capacity (e.g., attributed to the more powerful CPUs on the general purpose computers on which the vSwitches typically run) but lower data plane throughput; and (3) operation of SDN switches cooperating in reactive mode can be easily disrupted by various conditions which impact communications between the central controller and switches controlled by the central controller (e.g., which may include naturally occurring conditions, attacks, or the like). Based on these and other observations and measurements, various embodiments for scaling SDN control plane capacity to improve SDN control plane throughput and resiliency are presented herein.

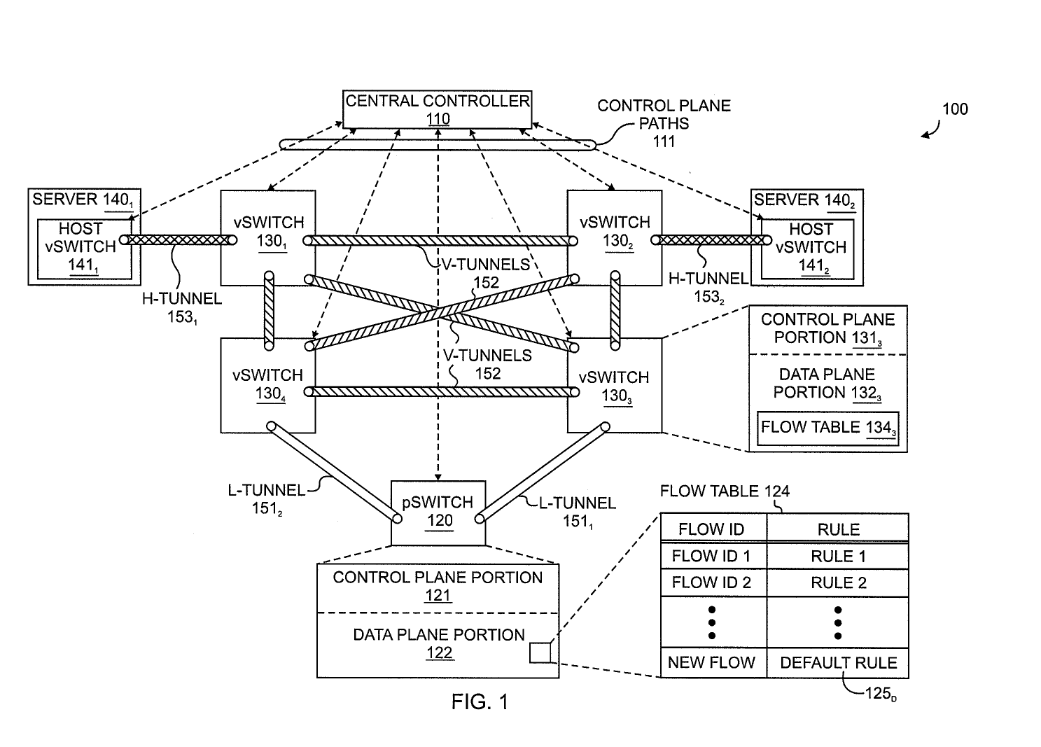

Various embodiments of the capability for scaling of the SDN control plane capacity may utilize SDN data plane capacity in order to scale the SDN control plane capacity. The SDN data plane capacity may be used to scale communication capacity between the central controller and the switches that are controlled by the central controller. More specifically, the relatively high availability of SDN data plane capacity may be exploited to significantly scale the achievable throughput between the central controller and the switches that are controlled by the central controller. In at least some embodiments, the SDN control plane capacity may be scaled using a vSwitch-based overlay network (at least some embodiments of which also may be referred to herein as SCOTCH) to provide additional SDN control plane capacity. Various embodiments of the capability for scaling of the SDN control plane capacity may be better understood by way of reference to an exemplary communication system using a vSwitch-based overlay network to provide scaling of SDN control plane capacity, as depicted in FIG. 1.

FIG. 1 depicts an exemplary communication system using a vSwitch-based overlay network to provide scaling of SDN control plane capacity of an SDN. As depicted in FIG. 1, communication system 100 is an OpenFlow-based SDN including a central controller (CC) 110, a physical switch (pSwitch) 120, a set of virtual switches (vSwitches) 130₁-130₄ (collectively, vSwitches 130), and a set of servers 140₁-140₂ (collectively, servers 140). The pSwitch 120 includes a control plane portion 121 and a data plane portion 122. The servers 140₁ and 140₂ include host vSwitches 141₁ and 141₂ (collectively, host vSwitches 141), respectively.

The CC 110 may be implemented within communication system 110 in any suitable manner for implementing a central controller of an SDN. The CC 110 is configured to provide data forwarding control functions of the SDN within the communication system 100. The CC 110 is configured to communicate with each of the other elements of communication system 100 via respective control plane paths 111 (depicted as dashed lines within FIG. 1). The CC 110 is configured to provide various functions in support of embodiments of the capability for scaling of the SDN control plane capacity.

The pSwitch 120 is configured to provide data forwarding functions of the SDN within communication system 100. As discussed above, pSwitch 120 includes the control plane portion 121 and the data plane portion 122. It is noted that, given that the communication system 100 uses an OpenFlow based implementation of the SDN, the control plane portion 121 of pSwitch 120 is an OFA. As depicted in FIG. 1, the data plane portion 122 of pSwitch 120 includes a flow table 124 storing traffic flow rules 125 according to which packets of traffic flows received by pSwitch 120 are handled. As further depicted in FIG. 1, the traffic flow rules 125 include a default flow forwarding rule 125_{D} according to which packets of new traffic flows received by pSwitch 120 are handled. The modification and use of default flow forwarding rule 125_{D} on pSwitch 120 in this manner is described in additional detail below. The pSwitch 120 may be configured to provide various functions in support of embodiments of the capability for scaling of the SDN control plane capacity. The pSwitch 120 may be considered to provide a physical network portion of the SDN.

The vSwitches 130, similar to pSwitch 120, are configured to provide data forwarding functions of the SDN within communication system 100. Additionally, similar to pSwitch 120, each of the vSwitches 130 includes a control plane portion and a data plane portion, where the data plane portion includes a flow table storing traffic flow rules for the respective vSwitch 130. Additionally, also similar to pSwitch 120, the flow tables of the vSwitches 130 include default flow forwarding rules according to which packets of new traffic flows received by vSwitches 130 are to be handled, respectively. For purposes of clarity, only the details of vSwitch 130₃ are illustrated in FIG. 1. Namely, as depicted in FIG. 1, vSwitch 130₃ includes a control plane portion 131₃ and a data plane portion 132₃, and the data plane portion 132₃ includes a flow table 134₃ storing traffic flow rules (omitted for purposes of clarity). It is noted that, given that the communication system 100 uses an OpenFlow based implementation of the SDN, the control plane portions of vSwitches 130 may be implemented using OFAs, respectively. The vSwitches 130 are configured to provide various functions in support of embodiments of the capability for scaling of the SDN control plane capacity. The vSwitches 130 may be considered to form an overlay configured to enable scaling of the control plane portion of the SDN.

The vSwitches 130 may be implemented within communication system 100 in any suitable manner for implementing vSwitches. The vSwitches 130 may be implemented using virtual resources supported by underlying physical resources of communication system 100. For example, a vSwitch 130 may be embedded into installed hardware, included in server hardware or firmware, or implemented in any other suitable manner. The vSwitches 130 may include one or more dedicated vSwitches, one or more dynamically allocated vSwitches, or the like, as well as various combinations thereof. The vSwitches 130 may be deployed at any suitable locations of the SDN. For example, where communication system 100 is a datacenter, vSwitches 130 may be instantiated on servers identified as being underutilized (e.g., relatively lightly loaded with underutilized link capacity). For example, where the communication system 100 is a datacenter, the vSwitches 130 may be distributed across different racks in the datacenter. The typical implementation of a vSwitch will be understood by one skilled in the art.

The servers 140 are devices configured to support hosts to which traffic received at the communication system 100 may be delivered using the underlying SDN (which are omitted for purposes of clarity). For example, the hosts of servers 140₁ and 140₂ may be implemented as VMs for which traffic received at the communication system 100 may be intended. As discussed above, servers 140₁ and 140₂ include respective host vSwitches 141₁ and 141₂, which may be configured to handle forwarding of packets received at servers 140, respectively. The servers 140 and associated host vSwitches 141 may be implemented in any other suitable manner.

The communication system 100 includes three types of tunnels used to support communications between the various elements of the SDN: L-tunnels 151, V-tunnels 152, and H-tunnels 153. The L-tunnels 151 are established as data plane tunnels between pSwitch 120 and vSwitches 130 (illustratively, a first L-tunnel 151₁ between pSwitch 120 and vSwitch 130₃, and a second L-tunnel 151₂ between pSwitch 120 and vSwitch 130₄). The V-tunnels 152 are established as data plane tunnels between vSwitches 130, thereby forming an overlay network of vSwitches 130 (also referred to herein as a vSwitch-based overlay network or vSwitch-based overlay). The H-tunnels 153 are established as data plane tunnels between vSwitches 130 and host vSwitches 141 of servers 140 (illustratively, a first H-tunnel 153₁ between vSwitch 130₁ and host vSwitch 141₁, and a second H-tunnel 153₂ between vSwitch 130₂ and host vSwitch 141₂). The various tunnels 151, 152, and 153 provide an overlay network for the SDN. The tunnels 151, 152, and 153 may be established using any suitable tunneling protocols (e.g., Multiprotocol Label Switching (MPLS), Generic Routing Encapsulation (GRE), MAC-in-MAC, or the like, as well as various combinations thereof).

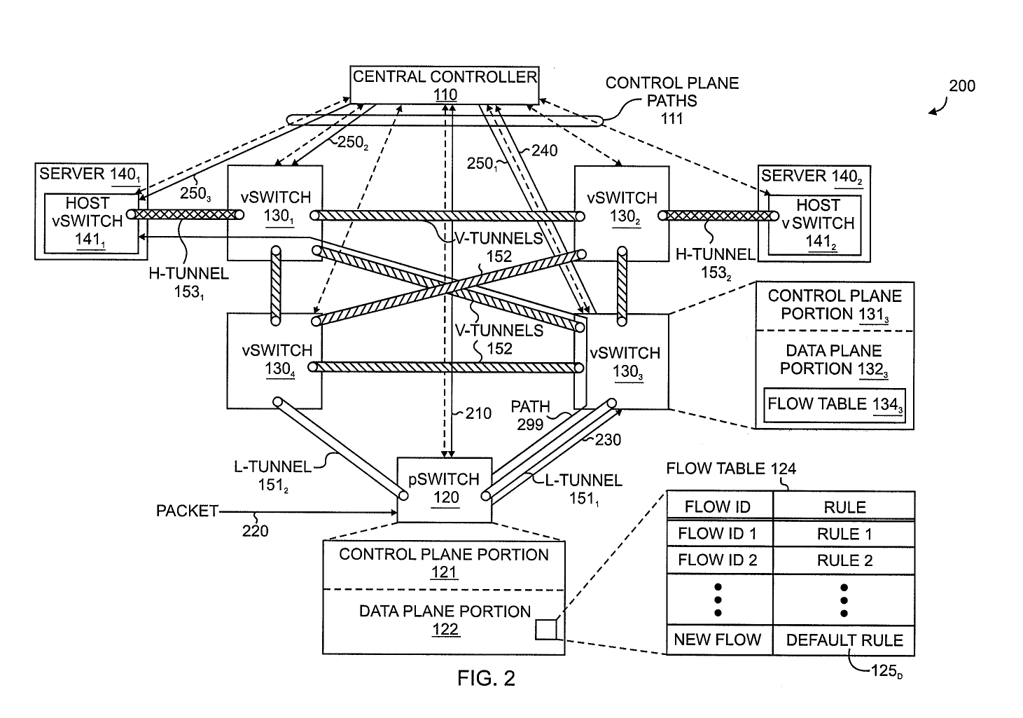

The operation of communication system 100 in providing various functions of the capability for scaling of the SDN control plane capacity for handling of a new traffic flow received at the SDN may be better understood by way of reference to FIG. 2.

FIG. 2 depicts the communication system of FIG. 1, illustrating use of the vSwitch-based overlay network to support establishment of a data path through the SDN for a new traffic flow. In the example of FIG. 2, the new traffic flow received at the SDN enters the SDN at the pSwitch 120 and is intended for delivery to a host on server 140₁.

The CC 110 is configured to monitor the control plane portion 121 of pSwitch 120 and, responsive to detection of a congestion condition associated with the control plane portion 121 of pSwitch 120, to control reconfiguration of the data plane portion of pSwitch 120 to alleviate or eliminate the detected congestion condition associated with the control plane portion 121 of pSwitch 120. The CC 110 may monitor the control plane portion 121 of pSwitch 120 by monitoring the load the control plane path 111 between CC 110 and the pSwitch 120. For example, CC 110 may monitor the rate of messages sent from the control plane portion 121 of pSwitch 120 to the CC 110 in order to determine if the control plane portion 121 of pSwitch 120 is overloaded (e.g., where the rate of messages exceeds a threshold). The CC 110 is configured to modify the default flow forwarding rule 125_{D} of pSwitch 120 based on a determination that the control plane portion 121 of pSwitch 120 is overloaded. In a typical SDN, the default flow forwarding rule 125_{D} would specify that an indication of the first packet of a new traffic flow received by pSwitch 120 is to be directed to the CC 110 as a Packet-In message; however, in the SDN of the system of FIG. 1, the default flow forwarding rule 125_{D} on pSwitch 120 is modified, under the control of CC 110 via the corresponding control plane path 111 to specify that an indication of the first packet of a new traffic flow received by pSwitch 120 is to be directed by pSwitch 120 to either the vSwitch 130₃ or the vSwitch 130₄ (which may in turn direct the new traffic flows to the CC 110) rather than to CC 110. The modification of the default flow forwarding rule 125_{D} on pSwitch 120 in this manner reduces the load on the control plane portion 121 of the pSwitch 120 by (1) causing the first packets of new traffic flows to leave the pSwitch 120 via the data plane portion 122 of the pSwitch 120 rather than via the control plane portion 121 of the pSwitch 120 and (2) causing the vSwitches 130₃ and 130₄ to handle traffic flow setup and packet forwarding for new traffic flows received at the pSwitch 120. The CC 110 modifies the default flow forwarding rule 125_{D} on pSwitch 120 by sending a flow table modification command to pSwitch 120 via the control plane path 111 between CC 110 and the pSwitch 120 (depicted as step 210 in FIG. 2).

The pSwitch 120 is configured to receive a packet of a traffic flow via an external interface (depicted as step 220 in FIG. 2). The received packet includes flow information which may be used to differentiate between packets of different traffic flows within the SDN (e.g., a five-tuple of header fields of the packet, or any other suitable information on which traffic flows may be differentiated within an SDN). The data plane portion 122 of pSwitch 120 performs a lookup in the flow table 124, based on the flow information of the received packet, to try to identify the traffic flow with which the packet is associated. If the packet is not the first packet of the traffic flow, data plane portion 122 of pSwitch 120 will identify an entry of flow table 124 having a flow identifier matching the flow information of the received packet, in which case the data plane portion 122 of pSwitch 120 can process and forward the received packet based on the traffic flow rule of the identified entry of flow table 124. However, as discussed above, if the packet is the first packet of the traffic flow, an entry will not exist in flow table 124 for the traffic flow such that data plane portion 122 of pSwitch 120 will not be able to identify an entry of flow table 124 having a flow identifier matching the flow information of the received packet in which case the data plane portion 122 of pSwitch 120 will process and forward the received packet based on the default flow forwarding rule 125_{D} of flow table 124. As described above, in a typical SDN the default flow forwarding rule 125_{D} would specify that an indication of the first packet of a new traffic flow received by pSwitch 120 is to be directed to the CC 110 as a Packet-In message; however, in the SDN of the system of FIG. 2, the default flow forwarding rule 125_{D} on pSwitch 120 has been modified, under the control of CC 110, to specify that an indication of the first packet of a new traffic flow received by pSwitch 120 is to be directed by pSwitch 120 to either the vSwitch 130₃ or the vSwitch 130₄ (which may in turn direct the new traffic flow to the CC 110) rather than to CC 110. In this case, assume that the default flow forwarding rule 125_{D} specifies that an indication of the first packet of a new traffic flow received by pSwitch 120 is to be directed by pSwitch 120 to the vSwitch 130₃. Accordingly, the data plane portion 122 of pSwitch 120 tunnels the first packet of the new traffic flow to the vSwitch 130₃ via the L-tunnel 151₁ between pSwitch 120 and vSwitch 130₃ (depicted as step 230 of FIG. 2).

The vSwitch 130₃ is configured to receive the first packet of the new traffic flow from the data plane portion 122 of pSwitch 120 via the L-tunnel 151₁ between pSwitch 120 and vSwitch 130₃ (depicted as step 230 in FIG. 2). The data plane portion 131₃ of vSwitch 130₃, like the data plane portion 121 of pSwitch 120, performs a lookup to flow table 134₃ based on flow information in the first packet of the new traffic flow to try to identify the traffic flow with which the first packet of the new traffic flow is associated. Here, since the packet is the first packet of a new traffic flow to the SDN, an entry will not exist in flow table 134₃ for the traffic flow and, thus, the data plane portion 132₃ of vSwitch 130₃ will process and forward the packet based on the default flow forwarding rule of flow table 134₃. The default flow forwarding rule of flow table 134₃ specifies that an indication of the first packet of a new traffic flow received by vSwitch 130₃ is to be directed by vSwitch 130₃ to CC 110 (since vSwitch 130₃ is configured to forward new flows to CC 110 on behalf of pSwitch 120). Accordingly, the data plane portion 132₃ of vSwitch 130₃ forwards the first packet of the new traffic flow to CC 110, via the associated control plane path 111 between vSwitch 130₃ and CC 110, as a Packet-In message (depicted as step 240 of FIG. 2). In this manner, generation and propagation of the Packet-In message for the first packet of the new traffic flow is offloaded from the control plane of the SDN (namely, the control plane portion 121 of pSwitch 120 does not need to generate and forward the Packet-In message for the first packet of the new traffic flow and, further, the resources of the control plane path 111 between pSwitch 120 and CC 110 are not consumed by propagation of the Packet-In message to CC 110 for establishment of a path through the SDN for the new traffic flow).

The CC 110 is configured to receive the Packet-In message from the vSwitch 130₃ via the control plane path 111 between vSwitch 130₃ and CC 110. The CC 110 processes the Packet-In message for the new flow in order to determine a path for the new traffic flow through the SDN. As noted above, the new traffic flow received at the SDN is intended for delivery to a host on server 140₁. Thus, CC 110 determines that the routing path for the new traffic flow is pSwitch 120→vSwitch 130₃→vSwitch 130₁→host vSwitch 141₁→destination host on server 140₁. The CC 110 generates flow forwarding rules for the new traffic flow for each of the forwarding elements along the routing path determined for the new traffic flow and forwards the flow forwarding rules for the new traffic flow to each of the forwarding elements along the routing path via control plane paths 111 between CC 110 and the forwarding elements along the determined routing path, respectively. The flow forwarding rules for the forwarding elements each include a flow identifier to be used by the forwarding elements to identify packets of the new traffic flow. The CC 110 may determine the flow identifier for the new traffic flow in any suitable manner (e.g., based on flow information included in the Packet-In message received by the CC 110). Namely, as depicted in FIG. 2, CC 110 (a) generates a flow forwarding rule for vSwitch 130₃ (e.g., including the flow identifier for the new traffic flow and an indication that packets of the new traffic flow are to be forwarded to vSwitch 130₁ via the associated V-tunnel 152 between vSwitch 130₃ and vSwitch 130₁) and sends the flow forwarding rule to vSwitch 130₃ for inclusion in the flow forwarding table of vSwitch 130₄ (depicted as step 250₁), (b) generates a flow forwarding rule for vSwitch 130₁ (e.g., including the flow identifier for the new traffic flow and an indication that packets of the new traffic flow are to be forwarded to host vSwitch 141₁ via the associated H-tunnel 153₁) and sends the flow forwarding rule to vSwitch 130₁ for inclusion in the flow forwarding table of host vSwitch 141₁ (depicted as step 250₂), and (c) generates a flow forwarding rule for host vSwitch 141₁ (e.g., including the flow identifier for the new traffic flow and an indication that packets of the new traffic flow are to be forwarded to the destination host) and sends the flow forwarding rule to host vSwitch 141₁ for inclusion in the flow forwarding table of host vSwitch 141₁ (depicted as step 250₃). The installation of the flow forwarding rules for the new traffic flow on the forwarding elements of the determined routing path results in routing path 299 that is depicted in FIG. 2. It is noted that the CC 110 alternatively could have determined that the routing path for the new traffic flow is pSwitch 120 vSwitch 130₄→vSwitch 130₁→host vSwitch 141₁→destination host on server 140₁, however, this would have required extra steps of generating a flow forwarding rule for pSwitch 120 and sending the flow forwarding rule to pSwitch 120 in order to configure pSwitch 120 to send packets of the traffic flow to vSwitch 130₄ instead of vSwitch 130₃ to which the first packet of the traffic flow was sent. It is further noted that the CC 110 also could have determined that the routing path for the new traffic flow is pSwitch 120→vSwitch 130₄→vSwitch 130₁→host vSwitch 141₁→destination host on server 140₁ without requiring the extra steps discussed above if the CC 110 had provided the first packet of the traffic flow to vSwitch 130₄ instead of vSwitch 130₃.

In at least some embodiments, the vSwitch-based overlay of FIGS. 1 and 2 may be configured to support balancing of traffic load across the vSwitches 130 in the vSwitch-based overlay. It may be necessary or desirable to balance the load across the vSwitches 130 in the vSwitch-based overlay in order to avoid or reduce performance bottlenecks. In at least some embodiments, load balancing of handling of new traffic flows may be provided by load-balancing on a per-pSwitch basis, such as where a pSwitch is associated with multiple vSwitches configured to handle new traffic flows on behalf of the pSwitch. This is illustrated in FIGS. 1 and 2, where new traffic flows received at pSwitch 120 may be load balanced across vSwitches 130₃ and 130₄. Similarly, in at least some embodiments, when multiple vSwitches are used to handle new traffic flows of a given pSwitch, load balancing of packets of the traffic flows across the vSwitches may be provided (again, illustratively, load balancing of packets of traffic flows from pSwitch 120 across vSwitches 130₃ and 130₄). In at least some embodiments, load balancing across multiple vSwitches may be provided by selecting between the L-tunnels that connect the given physical switch to the vSwitches, respectively (illustratively, the L-tunnels 151₁ and 151₂ from pSwitch 120 to vSwitches 130₃ and 130₄). In at least some embodiments, load balancing across multiple vSwitches may be provided using the group table feature of OpenFlow Switch Specification 1.3. In general, a group table includes multiple group entries, where each group entry includes a group identifier, a group type (defining group semantics), counters, and action buckets (where action buckets include an ordered list of action buckets, where each action bucket includes a set of actions to be executed and associated parameters of the actions). In at least some embodiments, load balancing may be provided by using select group type, which selects one action bucket in the action buckets that is to be executed. It is noted that the bucket selection process is not defined in OpenFlow Switch Specification 1.3; rather, implementation is left to the OpenFlow switch vendor (e.g., the bucket selection process may utilize a hash function based on flow identifier or may utilize any other suitable method of supporting bucket selection). In at least some embodiments, for the L-tunnels connecting the given pSwitch to the respective vSwitches, a corresponding action bucket is defined for the L-tunnel and the action of the action bucket is to forward packets received at the pSwitch to the vSwitch using the corresponding L-tunnel.

In at least some embodiments, the vSwitch-based overlay of FIGS. 1 and 2 may be configured to enable identification of new traffic flows at CC 110. As discussed above, for a first packet of a new traffic flow received at pSwitch 120, CC 110 may receive the associated Packet-In message from pSwitch 120 or from vSwitch 130₃. The CC 110, when receiving the Packet-In message from vSwitch 130₃, still needs to know that pSwitch 120 received the first packet of the new traffic flow that caused the associated Packet-In message to be provided to CC 110 by vSwitch 130₃. Thus, in order to enable CC 110 to identify a new traffic flow forwarded to CC 110 indirectly via vSwitch 130₃ on behalf of pSwitch 120, the Packet-In message that is received at CC 110 from vSwitch 130₃ needs to include information that would be included in the Packet-In message if the Packet-In message was sent directly from pSwitch 120 to CC 110. This is expected to be true for most of the information that is typically included within a Packet-In message, however, there may be two exceptions in that, when a Packet-In message is sent to CC 110 by vSwitch 130₃ responsive to receipt by the vSwitch 130₃ of the first packet of the new traffic flow from pSwitch 120, the Packet-In message does not include the physical switch identifier of pSwitch 120 or the original ingress port identifier of pSwitch 120 via which the first packet of the new traffic flow was received at pSwitch 120.

In at least some embodiments, the CC 110 may be configured to determine the physical switch identifier of pSwitch 120 when vSwitch 130₃ provides the Packet-In message to CC 110 on behalf of pSwitch 120. The CC 110 may be configured to determine the physical switch identifier of pSwitch 120 based on a mapping of tunnel identifiers to switch identifiers that is maintained at CC 110. The mapping of tunnel identifiers to switch identifiers is a mapping of identifiers of L-tunnels to identifiers of pSwitches with which the L-tunnels are associated (illustratively, mapping of the two L-tunnels 151 to the pSwitch 120). The CC 110 may be configured such that, upon receiving a Packet-In message from vSwitch 130₃, CC 110 may identify a tunnel identifier in the Packet-In message and perform a lookup using the tunnel identifier as a key in order to determine the physical switch identifier associated with the tunnel identifier (where the physical switch identifier identifies the pSwitch 120 from which vSwitch 130₃ received the first packet of the new traffic flow).

In at least some embodiments, vSwitch 130₃ may be configured to determine the physical switch identifier of pSwitch 120 and inform CC 110 of the physical switch identifier of pSwitch 120. The vSwitch 130₃ may be configured to determine the physical switch identifier of pSwitch 120 based on a mapping of tunnel identifiers to physical switch identifiers and may include the determined physical switch identifier of the pSwitch 120 in the Packet-In message that is sent to CC 110. The mapping of tunnel identifiers to switch identifiers is a mapping of identifiers of L-tunnels to identifiers of pSwitches with which the L-tunnels are associated (illustratively, mapping of the two L-tunnels 151 to the pSwitch 120). The vSwitch 130₃ may be configured such that, upon receiving a first packet of a new traffic flow from pSwitch 120, vSwitch 130₃ may identify a tunnel identifier in the first packet of the new traffic flow, perform a lookup using the tunnel identifier as a key in order to determine the physical switch identifier associated with the tunnel identifier (where the physical switch identifier identifies the pSwitch 120 from which vSwitch 130₃ received the first packet of the new traffic flow), and include the physical switch identifier of pSwitch 120 in the Packet-In message that is sent to CC 110.

In at least some embodiments, CC 110 may determine the original ingress port identifier of pSwitch 120 using an additional label or identifier. In at least some embodiments, pSwitch 120 may add the additional label or identifier to the first packet of the new traffic flow before sending the first packet of the new traffic flow to vSwitch 130₃, vSwitch 130₃ may add the additional label or identifier from the first packet of the new traffic flow to the Packet-In message sent to CC 110 by vSwitch 130₃, and CC 110 may determine the original ingress port identifier of pSwitch 120 using the additional label or identifier in the Packet-In message received from vSwitch 130₃. In embodiments in which MPLS is used for tunneling packets within the vSwitch-based overlay, for example, pSwitch 120 may push an inner MPLS label into the packet header of the first packet of the new traffic flow based on the original ingress port identifier and send the first packet of the new traffic flow to vSwitch 130₃, vSwitch 130₃ may then access the inner MPLS label (e.g., after removing the outer MPLS label used to send the first packet of the new traffic flow from pSwitch 120 to vSwitch 130₃) and include the inner MPLS label in the Packet-In message sent to CC 110, and CC 110 may determine the original ingress port identifier of pSwitch 120 based on the inner MPLS label in the Packet-In message. In embodiments in which GRE is used for tunneling packets within the vSwitch-based overlay, for example, pSwitch 120 may set a GRE key within the packet header of the first packet of the new traffic flow based on the original ingress port identifier and send the first packet of the new traffic flow to vSwitch 130₃, vSwitch 130₃ may then access the GRE key and include the GRE key in the Packet-In message sent to CC 110, and CC 110 may determine the original ingress port identifier of pSwitch 120 based on the GRE key in the Packet-In message. It will be appreciated that the original ingress port identifier of pSwitch 120 may be communicated to CC 110 in other ways (e.g., embedding by pSwitch 120 of the original ingress port identifier within an unused field of the header of the first packet of the new traffic flow and then embedding by vSwitch 130₃ of the original ingress port identifier within an unused field of the header of the associated Packet-In message sent by vSwitch 130₃ to CC 110, configuring vSwitch 130₃ to determine the original ingress port identifier based on a mapping of the additional label or identifier to the original ingress port identifier and to include the original ingress port identifier within the associated Packet-In message sent to CC 110, or the like, as well as various combinations thereof).

In at least some embodiments, the vSwitch-based overlay of FIGS. 1 and 2 may be configured to support traffic flow grouping and differentiation in a manner enabling mitigation of SDN control plane overload. As discussed above, when a new traffic flow arrives at CC 110, CC 110 has three choices for handing of the new traffic flow, as follows: (1) forwarding the new traffic flow using the physical network, starting from the original physical switch which received the first packet of the new traffic flow (illustratively, pSwitch 120); (2) forwarding the new traffic flow using the vSwitch overlay network, starting from the first vSwitch 130; and (3) dropping the new traffic flow based on a determination that the new traffic flow should or must be dropped (e.g., based on a determination that load on the SDN exceeds a threshold, based on identification of the new traffic flow as being part of a DoS attack on the SDN, or the like).

In at least some embodiments, the vSwitch-based overlay of FIGS. 1 and 2 may be configured to provide separate handling of small flows and large flows within the SDN. In many cases, it will not be sufficient to address the performance bottlenecks at any one pSwitch or subset of pSwitches. This may be due to the fact that, when one pSwitch is overloaded, it is likely that other pSwitches are overloaded as well. This is particularly true if the overload is caused by a situation that generates large numbers of small flows in any attempt to overload the control plane (e.g., an attempted DoS attack). Additionally, if an attacker spoofs packets from multiple sources to a single destination, then even if the new traffic flows arriving at the first-hop physical switch are distributed to multiple vSwitches 130, the pSwitch close to the single destination will still be overloaded since rules have to be inserted at the pSwitch for each new traffic flow that is received at the pSwitch. In at least some embodiments, this problem may be alleviated or even avoided by forwarding some or all of the new flows on the vSwitch-based overlay so that the new rules that are inserted for some or all of the new flows are inserted at the vSwitches 130 rather than the pSwitches (although it is noted that a certain percentage of flows still may be handled by the pSwitches). In at least some embodiments, in which a relatively large percentage of traffic flows are likely to be relatively small (e.g., traffic flow from attempted DoS attacks), CC 110 may be configured to monitor traffic flows in order to identify relatively large flows and control migration of the relatively large flows back to paths that use pSwitches. It will be appreciated that since, in many cases, the majority of packets are expected to likely to belong to a relatively small number of relatively large flows, such embodiments enable effective use of the high control plane capacity of the vSwitches 130 and the high data plane capacity of the pSwitches.

In at least some embodiments, the vSwitch-based overlay of FIGS. 1 and 2 may be configured to enforce fair sharing of resources of the SDN. In at least some embodiments, traffic flows may be classified into two or more groups and fair sharing of SDN resources across the groups may be enforced. The classification of traffic flows may be based on any suitable characteristics of the traffic flows (e.g., customers with which the traffic flows are associated, ingress ports of pSwitches via which the traffic flows arrive at the SDN, types of traffic transported by the traffic flows, or the like, as well as various combinations thereof).

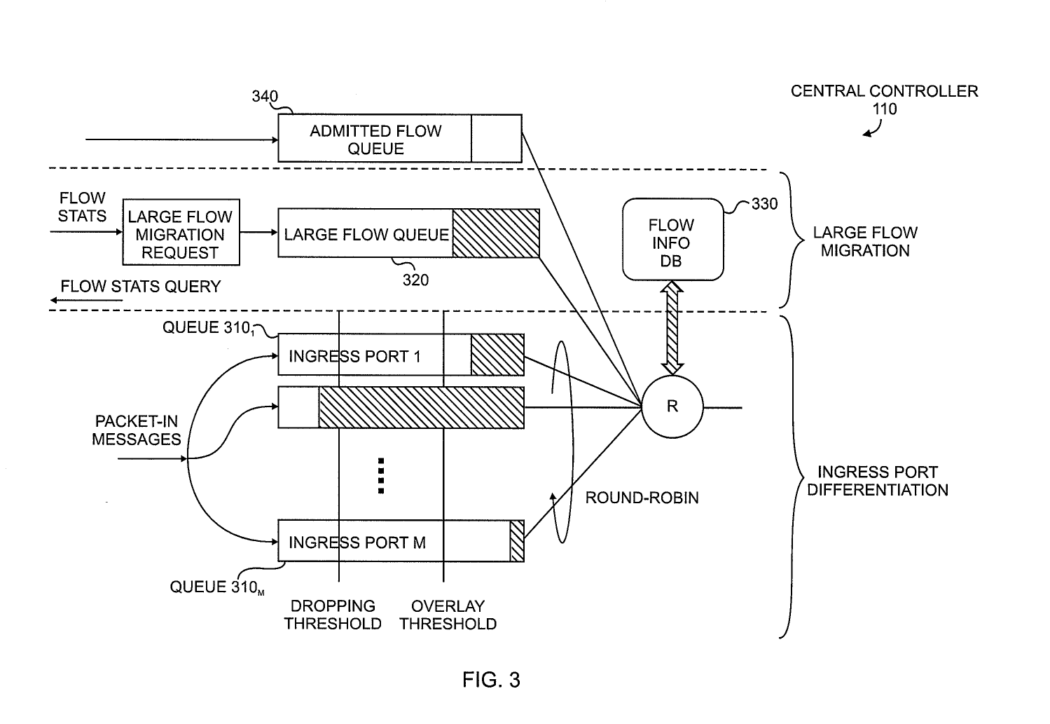

In at least some embodiments, as noted above, the vSwitch-based overlay of FIGS. 1 and 2 may be configured to enforce fair sharing of resources of the SDN based ingress port differentiation. In at least some embodiments, fair access to the SDN may be provided for traffic flows arriving via different ingress ports of the same pSwitch. This type of embodiment may be used to ensure that, if a DoS attack comes from one or few ports, the impact of the DoS attach can be limited to only those ports. For the new traffic flows arriving at the same pSwitch (e.g., pSwitch 120), the CC 110 maintains one queue per ingress port (depicted as queues 310₁-310_{M} (collectively, queues 310) in the lower portion of FIG. 3 which is labeled as “ingress port differentiation”). The queues 310 store Packet-In messages that are awaiting processing by CC 110. The service rate for the queues 310 is R, which is the maximum rate at which CC 110 can install rules at the pSwitch without insertion failure or packet loss in the data plane. The CC 110 is configured to serve the queues 310 in a round-robin fashion so as to share the available service rate evenly among the associated ingress ports of the pSwitch. The CC 110 may be configured to, based on a determination that the size of a queue 310 satisfies a first threshold that is denoted in FIG. 3 as an “overlay threshold” (e.g., a value indicative that the new traffic flows arriving at the ingress port of the pSwitch are beyond the control plane capacity of the control plane portion of the pSwitch), install flow forwarding rules at one or more corresponding vSwitches 130 so that the new traffic flows are routed over the vSwitch-based overlay network. The CC 110 may be configured to, based on a determination that the size of a queue 310 satisfies a second threshold that is denoted in FIG. 3 as a “dropping threshold” (e.g., a value indicative that new traffic flows arriving at the ingress port of the pSwitch need to be dropped), drop the Packet-In messages from the queue 310.

In at least some embodiments, the vSwitch-based overlay of FIGS. 1 and 2 may be configured to support migration of large traffic flows out of the vSwitch-based overlay. It is noted that, although the vSwitch-based overlay provides scaling of the SDN control plane capacity, there may be various cases in which it may be not desirable to forward traffic flows via the vSwitch-based overlay due to the fact that (1) the data plane portion 132 of a vSwitch 130 is expected to have much lower throughput than the data plane portion 122 of pSwitch 120 and (2) the forwarding path on the vSwitch-based overlay is expected to be longer than the forwarding path on the physical network. Accordingly, as noted above, the vSwitch-based overlay may be configured in a manner enabling the SDN to take advantage of the relatively high data plane capacity of the physical network. Measurement studies have shown that, in many cases, a majority of the link capacity is consumed by a small fraction of large traffic flows. Thus, in at least some embodiments, the vSwitch-based overlay may be configured to identify large traffic flows in the vSwitch-based overlay and to migrate the large traffic flows out of the vSwitch-based overlay and onto the physical network portion of the SDN. It is noted that, since it is expected that the SDN typically will include a relatively small number of such large traffic flows, it also is expected that the migration of large traffic flows out of the vSwitch-based overlay and onto the physical network portion of the SDN will not incur significant SDN control plane overhead.

In at least some embodiments, CC 110 may be configured to control large flow migration. In at least some embodiments, CC 110 may be configured to identify large traffic flows on the vSwitch-based overlay and control migration of large traffic flows from the vSwitch-based overlay to the physical network portion of the SDN. The CC 110 may be configured to identify large traffic flows on the vSwitch-based overlay by querying vSwitches 130 for flow stats of traffic flows on the vSwitch-based overlay (e.g., packet counts or other suitable indicators of traffic flow size) and analyzing the flow stats of traffic flows on the vSwitch-based overlay to identify any large traffic flows on the vSwitch-based overlay. The CC 110 may control migration of a large traffic flow from the vSwitch-based overlay to the physical network portion of the SDN by computing a path for the large traffic flow in the physical network portion of the SDN and controlling establishment of the path for the large traffic flow in the physical network portion of the SDN such that the large traffic flow continues to flow within the physical network portion of the SDN rather than the vSwitch-based overlay portion of the SDN. For example, CC 110 may control migration of a large traffic flow from the vSwitch-based overlay to the physical network portion of the SDN by computing a path for the large traffic flow in the physical network portion of the SDN and inserting associated flow forwarding rules into the flow tables of the pSwitch of the path computed for the large traffic flow in the physical network portion of the SDN (illustratively, into flow table 124 of pSwitch 120). It is noted that, in order to ensure that the path for the large traffic flow is established within the physical network portion of the SDN before the large traffic flow is migrated to the physical network portion of the SDN, the flow forwarding rule for the first pSwitch of the large traffic flow may be inserted into the flow table of the first pSwitch only after the flow forwarding rule(s) for any other pSwitches along the computed path have been inserted into the flow table(s) of any other pSwitches along the computed path (since the changing of the flow forwarding rule on the first pSwitch of the large traffic flow is what triggers migration of the large traffic flow such that the first pSwitch begins forwarding packets of the large traffic flow to a next pSwitch of the physical network portion of the SDN rather than to the vSwitches 130 of the vSwitch-based overlay portion of the SDN).

In at least some embodiments, CC 110 may be configured as depicted in FIG. 3 in order to control large flow migration. As depicted in FIG. 3, CC 110 sends flow-stat query messages to the vSwitches 130 (illustratively, denoted as FLOW STATS QUERY), receives flow-stat response messages from the vSwitches 130 (illustratively, denoted as FLOW STATS), and identifies any large traffic flows based on the flow stats for the traffic flows. The CC 110, upon identification of a large traffic flow on the basis of the flow statistics, inserts a large flow migration request (e.g., identified using a flow identifier of the identified large traffic flow) into large flow queue 320. The CC 110 then queries a flow information database 330 in order to identify the first-hop pSwitch of the large traffic flow. The CC 110 then computes a path to the destination for the large traffic flow in the physical network portion of the SDN, checks the message rates of each of the pSwitches on the computed path in the physical network portion of the SDN to ensure that the control plane portions of the pSwitches on the computed path in the physical network portion of the SDN are not overloaded, and sets up the computed path in the physical network portion of the SDN based on a determination that the pSwitches on the computed path in the physical network portion of the SDN are not overloaded. The CC 110 sets up the computed path in the physical network portion of the SDN by, generating a flow forwarding rule for each of the pSwitches on the computed path in the physical network portion of the SDN, inserting the flow forwarding rules for the pSwitches into an admitted flow queue 340, and sending flow forwarding rules to the pSwitches based on servicing of the admitted flow queue 340. As noted above, the flow forwarding rules for the pSwitches may be arranged within admitted flow queue 340 such that the flow forwarding rule is installed on the first-hop pSwitch of the computed path last (i.e., so that packets are forwarded on the new path only after all pSwitches on the new path are ready).

In at least some embodiments, CC 110 may be configured to give priority to its queues as follows: admitted flow queue 340 receives the highest priority, large flow queue 320 receives the next highest priority, and the queues 310 receive the lowest priority. The use of such a priority order causes relatively small traffic flows to be forwarded on the physical network portion of the SDN only after all of the large traffic flows have been accommodated.

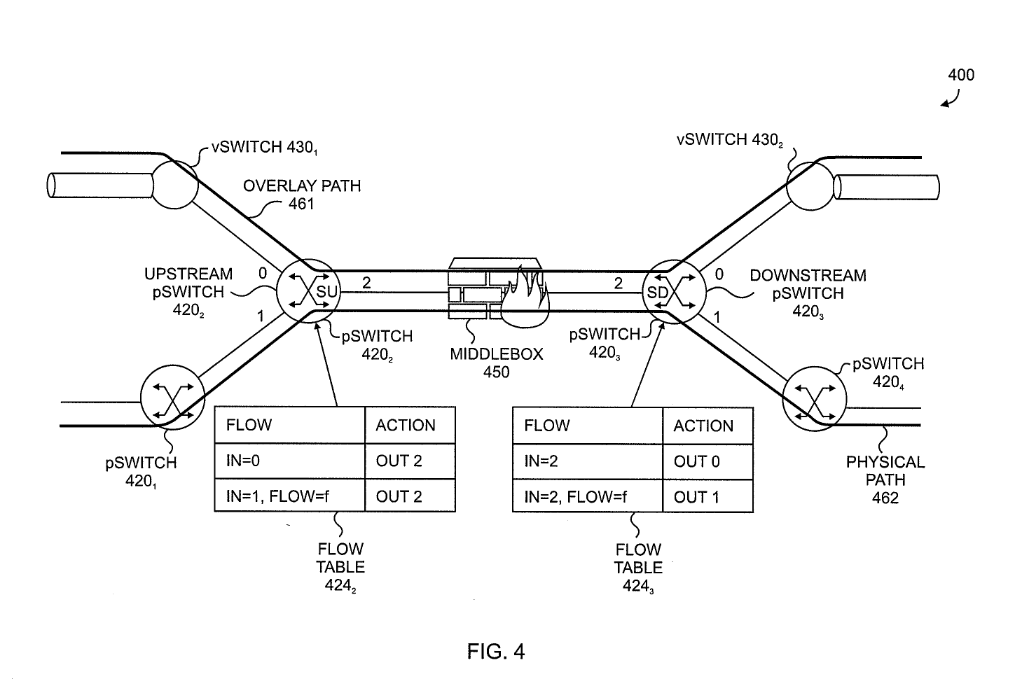

In at least some embodiments, the vSwitch-based overlay of FIGS. 1 and 2 may be configured to support migration of traffic flows from the vSwitch-based overlay to the physical network of the SDN in a manner for ensuring that the two routing paths satisfy the same policy constraints. The most common policy constraints are middlebox traversal constraints, in which the traffic flow must be routed across a sequence of middleboxes according to a specific order of the middleboxes. For example, the middleboxes may be firewalls or any other suitable types of middleboxes. It will be appreciated that a naive approach for migration of a traffic flow is to compute the new path of pSwitches for the traffic flow without considering the existing path of vSwitches for the traffic flow. For example, if the existing path of vSwitches for a traffic flow causes the traffic flow to be routed first through a firewall FW1 and then through a load balancer LB1, the new path for the traffic flow may be computed such that the new path for the traffic flow uses a different firewall FW2 and a different load balancer LB2. However, in many cases, this approach will not work (or may work at the expense of reduced performance and increased cost) since the middleboxes often maintain flow states for traffic flows (e.g., when a traffic flow is routed to a new middlebox in the middle of the connection, the new middlebox may either reject the traffic flow or handle the traffic flow differently due to lack of pre-established context). It is noted that, although it may be possible to transfer traffic flow states between old and new middleboxes, this may require middlebox-specific changes and, thus, may lead to significant development costs and performance penalties. In at least some embodiments, in order to avoid the need for support of middlebox state synchronization, the vSwitch-based overlay may be configured to support migration of a traffic flow from the vSwitch-based overlay to the physical network portion of the SDN in a manner that forces the traffic flow to traverse the same set of middleboxes in both the vSwitch path and the pSwitch path. An exemplary embodiment for a typical configuration is depicted in FIG. 4.

FIG. 4 depicts an exemplary portion of an SDN configured to support migration of a traffic flow from the vSwitch-based overlay network to the physical network portion of the SDN in a manner for ensuring that the same policy constraints are satisfied.

As depicted in FIG. 4, the exemplary SDN portion 400 includes four pSwitches 420₁-420₄ (collectively, pSwitches 420), two vSwitches 430₁-430₂ (collectively, vSwitches 430), and a middlebox 450. The pSwitches 420 include an upstream pSwitch 420₂ (denoted as SU) and a downstream pSwitch 420₃ (denoted as SD), where upstream pSwitch 420₂ is connected to an input of middlebox 450 and downstream pSwitch 420₃ is connected to an output of middlebox 450 (e.g., firewall), respectively. The upstream pSwitch 420₂ includes a flow table 424₂ and downstream pSwitch 420₃ includes a flow table 424₃. The vSwitch 430₁ and pSwitch 420₁ are connected to upstream pSwitch 420₂ upstream of the upstream pSwitch 420₂. The vSwitch 430₂ and pSwitch 420₄ are connected to downstream pSwitch 420₃ downstream of the downstream pSwitch 420₃.

As depicted in FIG. 4, an overlay path 461, which uses the vSwitch-based overlay, is established via vSwitch 430₁, upstream pSwitch 420₂, middlebox 450, downstream pSwitch 420₃, and vSwitch 430₂. As indicated by the two rules shown at the top of flow tables 424₂ and 424₃ of upstream pSwitch 420₂ and downstream pSwitch 420₃, respectively, any traffic flow received at upstream pSwitch 420₂ from vSwitch 430₁ is routed via this overlay path 461. In this configuration, for a tunneled packet received at vSwitch 430₁, vSwitch 430₁ decapsulates the tunneled packet before forwarding the packet to the connected upstream pSwitch 420₂ in order to ensure that the middlebox 450 sees the original packet without the tunnel header, and, similarly, vSwitch 430₂ re-encapsulates the packet so that the packet can be forwarded on the tunnel downstream of vSwitch 430₂. The two rules shown at the top of flow tables 424₂ and 424₃ of upstream pSwitch 420₂ and downstream pSwitch 420₃, respectively, ensure that the traffic flow on the overlay path 461 traverses the firewall. It is noted that all traffic flows on the overlay path 461 share the two rules shown at the top of flow tables 424₂ and 424₃ of upstream pSwitch 420₂ and downstream pSwitch 420₃, respectively.

As further depicted in FIG. 4, the central controller (which is omitted from FIG. 4 for purposes of clarity), based on a determination that a large flow (denoted as flow f) is to be migrated from the overlay path 461 which uses the vSwitch-based overlay to a physical path 462, inserts within flow tables 424₂ and 424₃ of upstream pSwitch 420₂ and downstream pSwitch 420₃ the two rules shown at the bottom of the flow tables 424₂ and 424₃ of upstream pSwitch 420₂ and downstream pSwitch 420₃, respectively. The insertion of the two rules shown at the bottom of the flow tables 424₂ and 424₃ of upstream pSwitch 420₂ and downstream pSwitch 420₃, respectively, causes migration of large flow f from the overlay path 461 to the physical path 462 which, as illustrated in FIG. 4, still traverses middlebox 450. It is noted that the two new flows only match the large flow f and, thus, will not impact the other traffic flows that remain on the overlay path 461. It is further noted that, as indicated above, since migration of large flows is expected to be performed relatively infrequently and migration of a large flow only requires insertion of a single traffic flow rule at each pSwitch, the migration of large flows from the vSwitch-based overlay to the physical network portion of the SDN is expected to be more scalable than migration of small flows from the vSwitch-based overlay to the physical network portion of the SDN while also enabling the benefits of per-flow policy control to be maintained within the SDN. It is further noted that, while it may generally be difficult to synchronize different portions of flow path migration perfectly due to delay variations on the control paths, there may not be any need to achieve or even pursue such synchronization since out of order delivery of packets may be handled at the destination (e.g., in FIG. 4, the two rules shown at the bottom of the flow tables 424₂ and 424₃ of upstream pSwitch 420₂ and downstream pSwitch 420₃, respectively, may be inserted independently such that, for at least part of the existence of the traffic flow, the traffic flow may use a combination of part of overlay path 461 and part of physical switch path).

It will be appreciated that, although primarily depicted and described with respect to a particular type of middlebox connection (illustratively, where middlebox 450 is disposed on a path between two pSwitches 420), various embodiments for migration of a traffic flow from the vSwitch-based overlay network to the physical network portion of the SDN in a manner for ensuring that the same policy constraints are satisfied may be provided where other types of middlebox connections are used. In at least some embodiments, for example, the middlebox may be integrated into the pSwitch (e.g., in FIG. 4, upstream pSwitch 420₂, downstream pSwitch 420₃, and middlebox 450 would be combined into a single pSwitch and the rules from associated flow tables 424₂ and 424₃ would be combined on the single pSwitch). In at least some embodiments, for example, the middlebox may be implemented as a virtual middlebox running on a VM (e.g., in FIG. 4, a vSwitch can run on the hypervisor of the middlebox host and execute the functions of upstream pSwitch 420₂ and downstream pSwitch 420₃). In at least some embodiments, for example, overlay tunnels may be configured to directly terminate at the middlebox vSwitch. Other configurations are contemplated.

It will be appreciated that, although primarily depicted and described with respect to a particular type of middlebox (namely, a firewall), various embodiments for migration of a traffic flow from the vSwitch-based overlay network to the physical network portion of the SDN in a manner for ensuring that the same policy constraints are satisfied may be provided where other types of middleboxes are used.

In at least some embodiments, the vSwitch-based overlay of FIGS. 1 and 2 may be configured to support withdrawal of traffic flows from the vSwitch-based overlay when the condition which caused migration of traffic flows to the vSwitch-based overlay clears (e.g., the DoS attack stops, the flash crowd is no longer present, or the like). The CC 110 may be configured to monitor the control plane portion 121 of pSwitch 120 and, responsive to detection that the condition associated with the control plane portion 121 of pSwitch 120 has cleared such that the control plane portion 121 of pSwitch 120 is no longer considered to be congested, to control reconfiguration of the data plane portion of pSwitch 120 to return to its normal state in which new traffic flows are forwarded to CC 110 (rather than to vSwitch 130₃). The CC 110 may monitor the control plane portion 121 of pSwitch 120 by monitoring the load on the control plane path 111 between CC 110 and the pSwitch 120. For example, CC 110 may monitor the rate of messages sent from the control plane portion 121 of pSwitch 120 to the CC 110 in order to determine if the control plane portion 121 of pSwitch 120 is no longer overloaded (e.g., where the rate of messages falls below a threshold). The withdrawal of traffic flows from the vSwitch-based overlay based on a determination that the control plane portion 121 of pSwitch 120 is no longer overloaded may consist of three steps as follows.

First, CC 110 ensures that traffic flows currently being routed via the vSwitch-based overlay continue to be routed via the vSwitch-based overlay. Namely, for each traffic flow currently being routed via the vSwitch-based overlay, CC 110 installs an associated flow forwarding rule in flow table 124 of pSwitch 120 which indicates that the traffic flow is to be forwarded to the vSwitch 130 to which it is currently forwarded. It is noted that, where large traffic flows have already been migrated from the vSwitch-based overlay to the physical network portion of the SDN, most of the traffic flows for which rules are installed are expected to be relatively small flows which may terminate relatively soon.

Second, CC 110 modifies the default flow forwarding rule 125_{D} of pSwitch 120. Namely, the default flow forwarding rule 125_{D} of pSwitch 120 is modified to indicate that Packet-In messages for new traffic flows are to be directed to CC 110 (rather than to vSwitch 130₃, as was the case when new traffic flows were offloaded from the control plane portion 121 of pSwitch 120 due to overloading of the control plane portion 121 of pSwitch 120). The CC 110 modifies the default flow forwarding rule 125_{D} on pSwitch 120 by sending a flow table modification command to pSwitch 120 via the control plane path 111 between CC 110 and the pSwitch 120.

Third, CC 110 continues to monitor the traffic flows which remain on the vSwitch-based overlay (e.g., those for which CC 110 installed rules in the flow table 124 of pSwitch 120 as described in the first step). The CC 110 continues to monitor the traffic flows which remain on the vSwitch-based overlay since one or more of these flows may become large flows over time. For example, the CC 110 may continue to monitor traffic statistics of each of the traffic flows which remain on the vSwitch-based overlay. The CC 110, based on a determination that one of the traffic flows has become a large traffic flow, may perform migration of the large traffic flow from the vSwitch-based overlay onto the physical network portion of the SDN as described above.

It will be appreciated that, although primarily depicted and described with respect to specific numbers and arrangements of pSwitches 120, vSwitches 130, and servers 140, any other suitable numbers or arrangements of pSwitches 120, vSwitches 130, or servers 140 may be used. In at least some embodiments, CC 110 (or any other suitable controller or device) may be configured to instantiate and remove vSwitches 130 dynamically (e.g., responsive to user requests, responsive to detection that more or fewer vSwitches 130 are needed to handle current or expected load on the SDN, or in response to any other suitable types of trigger conditions). In at least some embodiments, CC 110 may be configured to monitor vSwitches 130 and to initiate mitigating actions responsive to a determination that one of the vSwitches 130 has failed. In at least some embodiments, for example, CC 110 may monitor the vSwitches 130 based on the exchange of flow statistics via control plane paths 111 between CC 110 and the vSwitches 130 (e.g., detecting improper functioning or failure of a given vSwitch 130 based on a determination that the given vSwitch 130 stops responding to flow statistics queries from CC 110). In at least some embodiments, for example, CC 110, responsive to a determination that a given vSwitch 130 is not functioning properly or has failed, may remove the given vSwitch 130 from the vSwitch-based overlay (which may include re-routing of traffic flows currently being routed via the given vSwitch 130) and adding a replacement vSwitch 130 into the vSwitch-based overlay (e.g., via establishment of L-tunnels 151, V-tunnels 152, and H-tunnels 153).

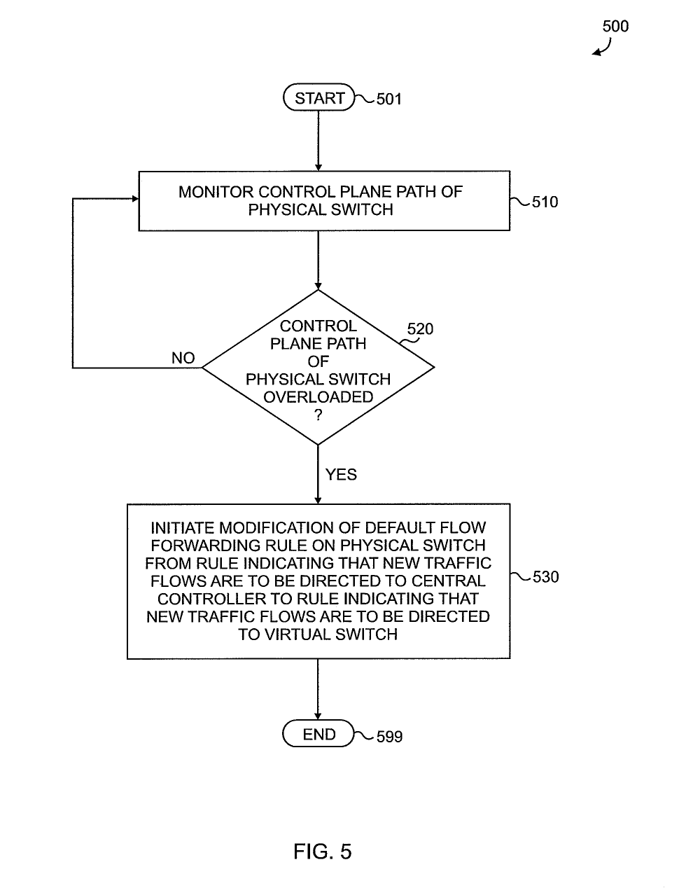

It will be appreciated that, although primarily depicted and described with respect to a communication system in which the SDN is based on OpenFlow, various embodiments depicted and described herein may be provided for communication systems in which the SDN is implemented using an implementation other than OpenFlow. Accordingly, various references herein to OpenFlow-specific terms (e.g., OFA, Packet-In, or the like) may be read more generally. For example, OFA may be referred to more generally as a control plane or control plane portion of a switch (e.g., pSwitch or vSwitch). Similarly, for example, a Packet-In message may be referred to more generally as a new flow request message. Various other more generalized terms may be determined from the descriptions or definitions of the more specific terms provided herein. For purposes of clarity in describing various functions supported by CC 110, pSwitch 120, and vSwitches 130, exemplary methods which may be supported by such elements within communication systems supporting OpenFlow or other various SDN implementations are depicted and described with respect to FIGS. 5-8.

FIG. 5 depicts one embodiment of a method for use by a central controller of an SDN using a vSwitch-based overlay network. It will be appreciated that, although depicted and described as being performed serially, at least a portion of the steps of method 500 may be performed contemporaneously or in a different order than depicted in FIG. 5. At step 501, method 500 begins. At step 510, the central controller monitors the control plane path of a physical switch. At step 520, the central controller makes a determination as to whether the control plane path of the physical switch is overloaded. If the control plane path of the physical switch is not overloaded, method 500 returns to step 510 (e.g., method 500 continues to loop within steps 510 and 520 until the central controller detects an overload condition on the control plane path of the physical switch). At step 530, the central controller initiates modification of a default flow forwarding rule at the physical switch, where the default flow forwarding rule at the physical switch is modified from indicating that new traffic flows received at the physical switch are to be directed to the central controller to indicating that new traffic flows received at the physical switch are to be directed to a virtual switch. At step 599, method 500 ends. It will be appreciated that a similar process may be used to initiate reversion of the default flow forwarding rule of the physical switch from indicating that new traffic flows received at the physical switch are to be directed to the virtual switch to indicating that new traffic flows received at the physical switch are to be directed to the central controller.

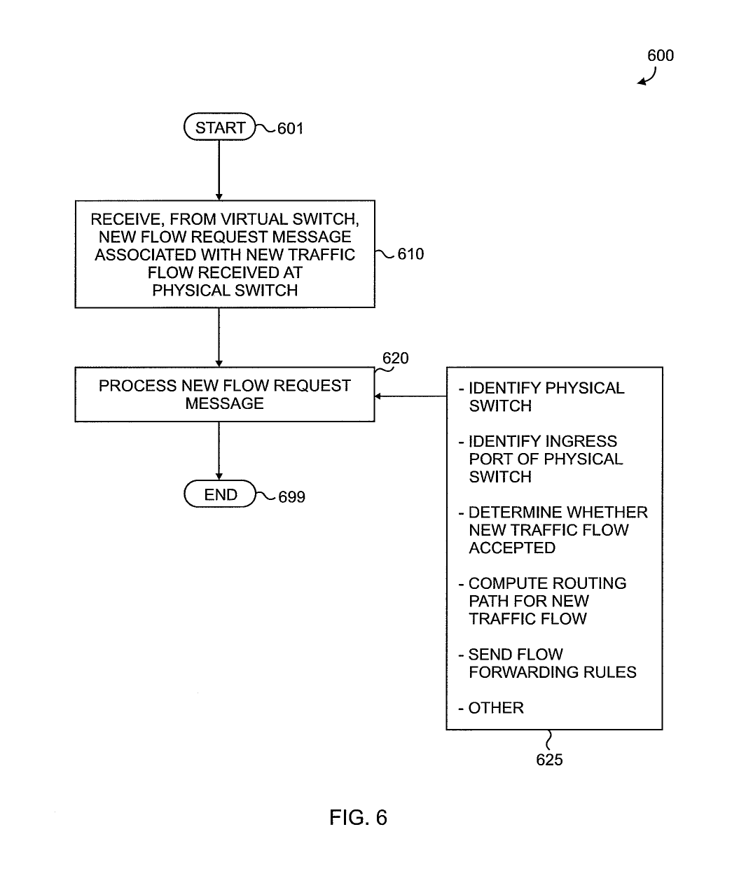

FIG. 6 depicts one embodiment of a method for use by a central controller of an SDN using a vSwitch-based overlay network. It will be appreciated that, although depicted and described as being performed serially, at least a portion of the steps of method 600 may be performed contemporaneously or in a different order than depicted in FIG. 6. At step 601, method 600 begins. At step 610, the central controller receives, from a virtual switch, a new flow request message associated with a new traffic flow received at a physical switch of the SDN. At step 620, the central controller processes the new flow request message. As indicated by box 625, processing of the new flow request message may include identifying the physical switch, identifying an ingress port of the physical switch via which the new traffic flow was received, determining whether to accept the new traffic flow into the SDN, computing a routing path for the new traffic flow, sending flow forwarding rules for the computed routing path to elements of the SDN, or the like, as well as various combinations thereof. At step 699, method 600 ends.

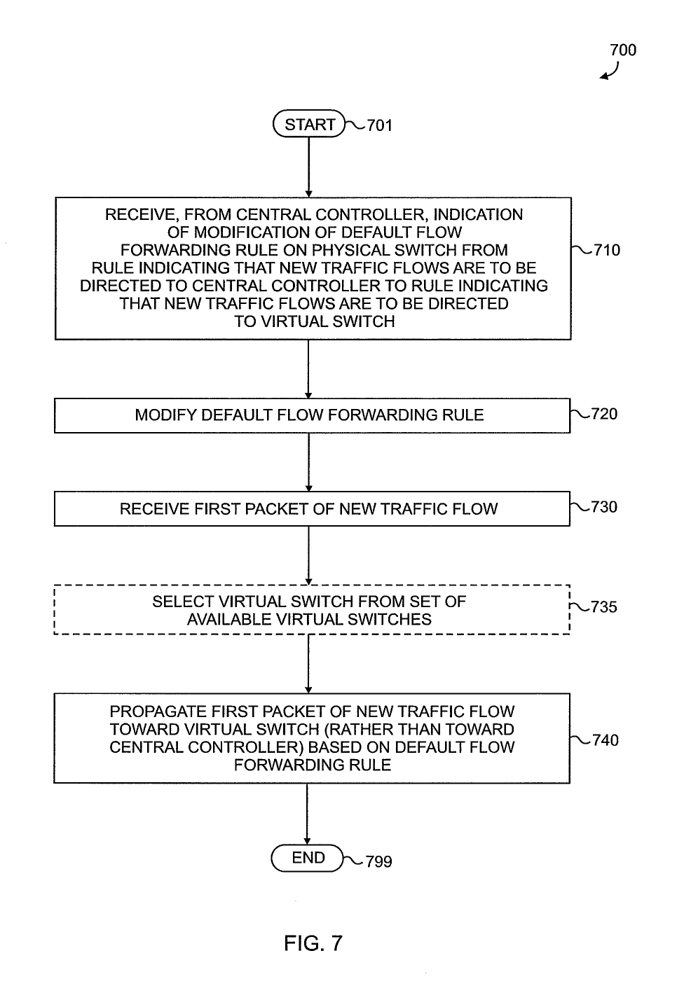

FIG. 7 depicts one embodiment of a method for use by a pSwitch of an SDN using a vSwitch-based overlay network. It will be appreciated that, although depicted and described as being performed serially, at least a portion of the steps of method 700 may be performed contemporaneously or in a different order than depicted in FIG. 7. At step 701, method 700 begins. At step 710, the physical switch receives, from the central controller, an indication of modification of a default flow forwarding rule at the physical switch, where the default flow forwarding rule at the physical switch is modified from indicating that new traffic flows received at the physical switch are to be directed to the central controller to indicating that new traffic flows received at the physical switch are to be directed to a virtual switch. At step 720, the physical switch modifies the default flow forwarding rule at the physical switch. At step 730, the physical switch receives a first packet of a new traffic flow. At step 735 (an optional step, depending on whether or not there is load balancing among multiple virtual switches), a virtual switch is selected from a set of available virtual switches. At step 740, the physical switch propagates the first packet of the new traffic flow toward the virtual switch (rather than toward the central controller) based on the default flow forwarding rule. At step 799, method 700 ends.

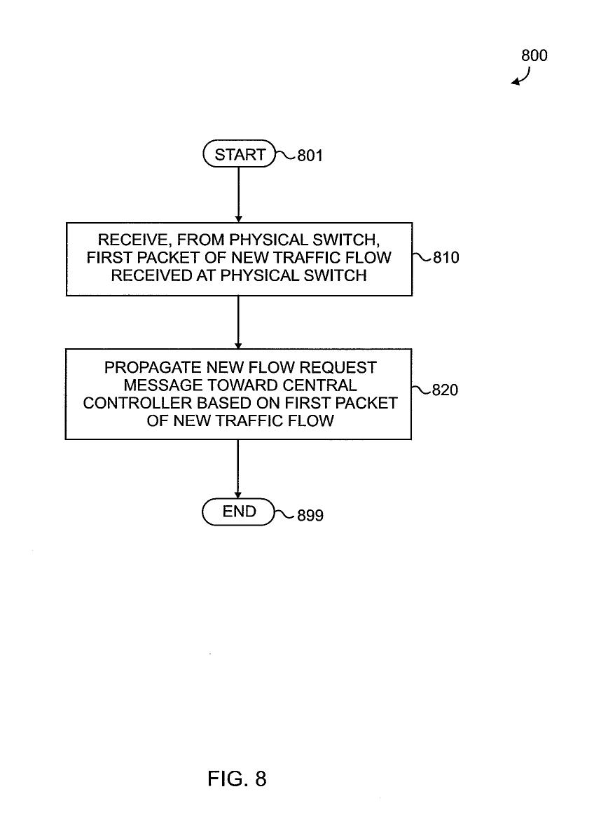

FIG. 8 depicts one embodiment of a method for use by a vSwitch of an SDN using a vSwitch-based overlay network. It will be appreciated that, although depicted and described as being performed serially, at least a portion of the steps of method 800 may be performed contemporaneously or in a different order than depicted in FIG. 8. At step 801, method 800 begins. At step 810, the virtual switch receives, from a physical switch, a first packet of a new traffic flow received at the physical switch. At step 820, the virtual switch propagates a new flow request message toward the central controller based on the first packet of the new traffic flow. At step 899, method 800 ends.

Various embodiments of the capability for scaling of the SDN control plane capacity enable use of both the high control plane capacity of a large number of vSwitches and high data plane capacity of hardware-based pSwitches in order to increase the scalability and resiliency of the SDN. Various embodiments of the capability for scaling of the SDN control plane capacity enable significant scaling of the SDN control plane capacity without sacrificing advantages of SDNs (e.g., high visibility of the central controller, fine-grained flow control, and the like). Various embodiments of the capability for scaling of the SDN control plane capacity obviate the need to use pre-installed rules in an effort to limit reactive flows within the SDN. Various embodiments of the capability for scaling of the SDN control plane capacity obviate the need to modify the control functions of the switches (e.g., the OFAs of the switches in an OpenFlow-based SDN) in order to scale SDN control plane capacity (e.g., obviating the need to use more powerful CPUs for the control functions of the switches, obviating the need to modify the software stack used by the control functions of the switches, or the like), which is not economically desirable due to the fact that the peak flow rate is expected to be much larger (e.g., several orders of magnitude) than the average flow rate. It will be appreciated that various embodiments of the capability for scaling of SDN control plane capacity provide other advantages for SDNs.

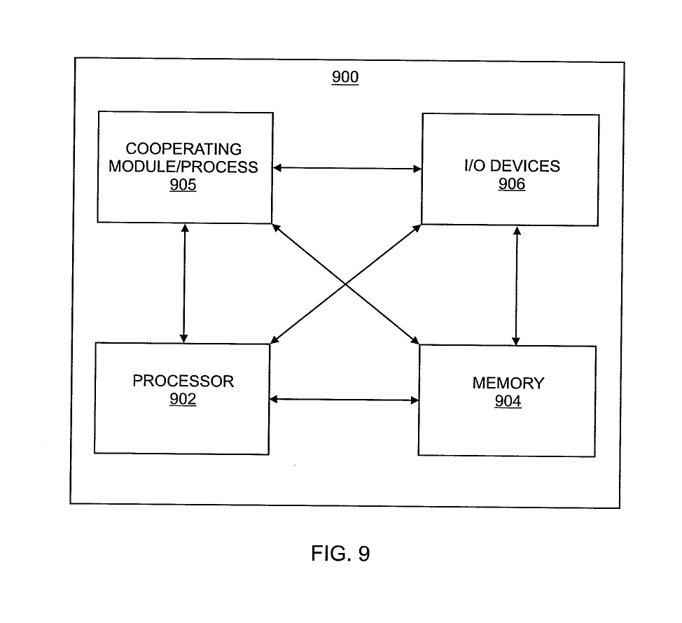

FIG. 9 depicts a high-level block diagram of a computer suitable for use in performing functions described herein.

The computer 900 includes a processor 902 (e.g., a central processing unit (CPU) and/or other suitable processor(s)) and a memory 904 (e.g., random access memory (RAM), read only memory (ROM), and the like).

The computer 900 also may include a cooperating module/process 905. The cooperating process 905 can be loaded into memory 904 and executed by the processor 902 to implement functions as discussed herein and, thus, cooperating process 905 (including associated data structures) can be stored on a computer readable storage medium, e.g., RAM memory, magnetic or optical drive or diskette, and the like.

The computer 900 also may include one or more input/output devices 906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof). It will be appreciated that computer 900 depicted in FIG. 9 provides a general architecture and functionality suitable for implementing functional elements described herein and/or portions of functional elements described herein. For example, the computer 900 provides a general architecture and functionality suitable for implementing CC 110, a portion of CC 110, a pSwitch 120, a portion of a pSwitch 120 (e.g., a control plane portion 121 of a pSwitch 120, a data plane portion 122 of a pSwitch 120, or the like), a vSwitch 130, a portion of a vSwitch 130 (e.g., a control plane portion 131 of a vSwitch 130, a data plane portion 132 of a vSwitch 130, or the like), a server 140, a host vSwitch 141, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. An apparatus for use in a software defined network, comprising:
a processor and a memory communicatively connected to the processor, the processor configured to:
propagate, toward a physical switch of the software defined network, a default flow forwarding rule indicative that, for new traffic flows received at the physical switch, associated indications of the new traffic flows are to be directed to a virtual switch.

2. The apparatus of claim 1, wherein the processor is configured to propagate the default flow forwarding rule toward the physical switch based on detection of a condition associated with a control plane path between the apparatus and the switch.

3. The apparatus of claim 2, wherein the processor is configured to:
monitor the control plane path between the apparatus and the physical switch for detection of the condition.

4. The apparatus of claim 2, wherein the processor is configured to:
based a determination that the condition associated with the control plane path between the apparatus and the physical switch has cleared:
propagate, toward the physical switch, a new default flow forwarding rule indicative that, for subsequent new traffic flows received by the physical switch, associated indications of the subsequent new traffic flows are to be directed to the apparatus.

5. The apparatus of claim 1, wherein the processor is configured to:
receive, from the virtual switch, a new flow request message associated with a first packet of a new traffic flow received by a physical switch of the software defined network; and
process the new flow request message received from the virtual switch.

6. An apparatus for use in a software defined network, comprising:
a processor and a memory communicatively connected to the processor, the processor configured to:
receive, from a virtual switch, a new flow request message associated with a first packet of a new traffic flow received by a physical switch of the software defined network; and
process the new flow request message received from the virtual switch.

7. The apparatus of claim 6, wherein the processor is configured to:
identify, based on the new flow request message, the physical switch that received the new traffic flow.

8. The apparatus of claim 7, wherein, to identify the physical switch that received the new traffic flow, the processor is configured to:
extract an identifier of the physical switch from a header portion of the new flow request message.

9. The apparatus of claim 7, wherein, to identify the physical switch that received the new traffic flow, the processor is configured to:
determine, from the new flow request message, an identifier of a tunnel between the physical switch and the virtual switch; and
determine an identifier of the physical switch based on a mapping of the identifier of the tunnel to the identifier of the physical switch.

10. The apparatus of claim 6, wherein the processor is configured to:
receive, from the virtual switch, flow statistics of traffic flows handled by the virtual switch;
identify one of the traffic flows having associated traffic flow statistics satisfying a migration rule; and
initiate migration of the identified one of the traffic flows from a current flow path to a new flow path.

11. An apparatus for use in a software defined network, comprising:
a memory configured to store a flow table including a default flow forwarding rule; and
a processor communicatively connected to the memory, the processor configured to:
receive a first packet of a new traffic flow; and
propagate the first packet of the new traffic flow toward a virtual switch based on the default flow forwarding rule.

12. The apparatus of claim 11, wherein the first packet of the new traffic flow is received via an ingress port of the apparatus, wherein the processor is configured to:
prior to propagating the first packet of the new traffic flow toward the virtual switch:
modify the first packet of the new traffic flow to include an identifier of the ingress port.

13. The apparatus of claim 11, wherein the processor is configured to:
select the virtual switch from a set of available virtual switches based on load balancing.

14. The apparatus of claim 1, wherein the processor is configured to:
receive a new default flow forwarding rule indicative that new flow request messages are to be propagated toward a central controller of the software defined network; and
update the flow table to replace the default flow forwarding rule with the new default flow forwarding rule.

15. The apparatus of claim 11, wherein the memory and the processor form at least part of a data plane portion of the apparatus, the apparatus further comprising a control plane portion configured for communication with a central controller of the software defined network via a control plane path.

16. An apparatus for use in a software defined network, comprising:
a processor and a memory communicatively connected to the processor, the processor configured to:
receive, from a physical switch of the software defined network, a first packet of a new traffic flow; and
propagate, toward a central controller of the software defined network, a new flow request message determined based on the first packet of the new traffic flow received from the physical switch.

17. The apparatus of claim 16, wherein the first packet of the new traffic flow is received via a tunnel between the physical switch and the apparatus, wherein the processor is configured to:
include an identifier of the tunnel in the new flow request message.

18. The apparatus of claim 16, wherein the first packet of the new traffic flow is received via a tunnel between the physical switch and the apparatus, wherein the processor is configured to:
determine an identifier of the physical switch based on a mapping of an identifier of the tunnel to the identifier of the physical switch; and
include the identifier of the physical switch in the new flow request message.

19. The apparatus of claim 16, wherein the processor is configured to:
determine, from the first packet of the new traffic flow, an identifier of an ingress port of the physical switch via which the first packet of the new traffic flow was received at the physical switch; and
include the identifier of the ingress port of the physical switch in the new flow request message.

20. The apparatus of claim 16, wherein the processor is configured to:
propagate, toward the central controller, flow statistics of traffic flows traversing the apparatus.
